(19) United States
(12) Patent Application Publication
(10) Pub. No.: US 2021/0106858 A1
(43) Pub. Date: Apr. 15, 2021

(54) PRESSURE-REGULATED HIGH PRESSURE STORAGE OF HALOCARBON FIRE EXTINGUISHING AGENT

(71) Applicant: Carrier Corporation, Jupiter, FL (US)

(72) Inventor: Paul M. Johnson, Clinton, MA (US)

(21) Appl. No.: 16/497,986

(22) PCT Filed: Mar. 28, 2018
(86) PCT No.: PCT/US2018/024783

§ 371 Date: Sep. 26, 2019

Related U.S. Application Data
(60) Provisional application No. 62/478,716, filed on Mar. 30, 2017.

(51) Int. Cl. A62C 35/68; A62C 35/02

(52) U.S. Cl. CPC A62C 35/68; A62C 35/023

(57) ABSTRACT

A system for storing a fire extinguishing agent is provided. The system comprises: a fire extinguishing tank configured to store fire extinguishing agent, the fire extinguishing tank having an orifice; and a valve located in the orifice configured to regulate pressure of the fire extinguishing agent exiting the fire extinguishing tank when the valve is opened; wherein the fire extinguishing agent comprises halocarbon.

### BACKGROUND

The embodiments herein generally relate to fire extinguishing systems and more specifically, the storage and disbursement of fire extinguishing agents.

Typically, halocarbon fire extinguishing tanks are pressurized with nitrogen, which acts as a propellant gas. Current tank valves open fully upon actuation thereby subjecting the pipe network to the fill cylinder pressure.

### BRIEF DESCRIPTION

According to one embodiment, a system for storing a fire extinguishing agent is provided. The system comprises: a fire extinguishing tank configured to store fire extinguishing agent, the fire extinguishing tank having an orifice; and a valve located in the orifice configured to regulate pressure of the fire extinguishing agent exiting the fire extinguishing tank when the valve is opened; wherein the fire extinguishing agent comprises halocarbon.

In addition to one or more of the features described above, or as an alternative, further embodiments of the system may include nitrogen gas located within the first extinguishing tank at a selected pressure, wherein the nitrogen gas propels the fire extinguishing agent through the valve when the valve is opened.

In addition to one or more of the features described above, or as an alternative, further embodiments of the system may include where the selected pressure of the nitrogen gas is greater than or equal to about 1800 psig.

In addition to one or more of the features described above, or as an alternative, further embodiments of the system may include where the valve further comprises: a valve housing; a valve inlet fluidly connecting the valve housing to the fire extinguishing tank; a valve outlet in the housing; and a piston within the valve housing, the piston dividing the valve into a first chamber and a second chamber, the second chamber fluidly connecting the valve inlet to the valve outlet when the valve is opened; wherein the piston is configured to move within the valve housing and adjust the flow of the fire extinguishing agent through the second chamber.

In addition to one or more of the features described above, or as an alternative, further embodiments of the system may include where the valve outlet is fluidly connected to the first chamber.

In addition to one or more of the features described above, or as an alternative, further embodiments of the system may include where the piston further includes a first side proximate the first chamber and a second side proximate the second chamber; and the first side includes a first surface area and the second side includes a second surface area, the first surface area being greater than the second surface area.

in addition to one or more of the features described above, or as an alternative, further embodiments of the system may include where the piston is configured to move when pressure at the valve outlet exceeds a selected outlet pressure.

In addition to one or more of the features described above, or as an alternative, further embodiments of the system may include where the piston is configured to move when pressure at the valve outlet exceeds a selected outlet pressure.

In addition to one or more of the features described above, or as an alternative, further embodiments of the system may include where the valve outlet is fluidly connected to the first chamber through a manifold configured to distribute the fire extinguishing agent when the valve is opened.

According to another embodiment, a method of assembling a fire extinguishing system is provided. The method of assembling comprises: obtaining a fire extinguishing tank having an orifice, the fire extinguishing tank being configured to store fire extinguishing agent; inserting a valve into the orifice, the valve being configured to regulate pressure of the fire extinguishing agent exiting the fire extinguishing tank when the valve is opened; wherein the fire extinguishing agent comprises halocarbon.

In addition to one or more of the features described above, or as an alternative, further embodiments of the method of assembling may include: filling the fire extinguishing tank with a first selected amount of the fire extinguishing agent.

In addition to one or more of the features described above, or as an alternative, further embodiments of the method of assembling may include: filling the fire extinguishing tank with a second selected amount of a nitrogen gas at a selected pressure, wherein the nitrogen gas propels the fire extinguishing agent through the valve when the valve is opened.

In addition to one or more of the features described above, or as an alternative, further embodiments of the method of assembling may include where the selected pressure of the nitrogen gas is greater than or equal to about 1800 psig.

In addition to one or more of the features described above, or as an alternative, further embodiments of the method of assembling may include where the valve further comprises: a valve housing; a valve inlet fluidly connecting the valve housing to the fire extinguishing tank; a valve outlet in the housing; and a piston within the valve housing, the piston dividing the valve into a first chamber and a second chamber, the second chamber fluidly connecting the valve inlet to the valve outlet when the valve is opened; wherein the piston is configured to move within the valve housing and adjust the flow of the fire extinguishing agent through the second chamber.

In addition to one or more of the features described above, or as an alternative, further embodiments of the method of assembling may include fluidly connecting the valve outlet to the first chamber.

In addition to one or more of the features described above, or as an alternative, further embodiments of the method of assembling may include where the piston further includes a first side proximate the first chamber and a second side proximate the second chamber; and the first side includes a first surface area and the second side includes a second surface area, the first surface area being greater than the second surface area.

In addition to one or more of the features described above, or as an alternative, further embodiments of the method of assembling may include where the piston is configured to move when pressure at the valve outlet exceeds a selected outlet pressure.

In addition to one or more of the features described above, or as an alternative, further embodiments of the method of assembling may include where the piston is configured to move when pressure at the valve outlet exceeds a selected outlet pressure.

In addition to one or more of the features described above, or as an alternative, further embodiments of the method of assembling may include where the valve outlet is fluidly connected to the first chamber through a manifold configured to distribute the fire extinguishing agent when the valve is opened.

According to another embodiment, a method of delivering fire extinguishing agent is provided. The method of delivering fire extinguishing agent may include: storing fire extinguishing agent within a fire extinguishing tank having an orifice; and regulating the pressure of fire extinguishing agent exiting the fire extinguishing tank using a valve located in the orifice; wherein the fire extinguishing agent comprises halocarbon.

Technical effects of embodiments of the present disclosure include regulating the pressure of fire extinguishing agent exiting a fire extinguishing tank using a valve.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The following descriptions should not be considered limiting in any way. With reference to the accompanying drawings, like elements are numbered alike:

FIG. 1 is a schematic illustration of a fire extinguishing system, according to an embodiment of the present disclosure;

FIG. 2 is a schematic illustration of a valve for use within the fire extinguishing system FIG. 1, according to an embodiment of the present disclosure;

FIG. 3 is a flow diagram illustrating a method of assembling the fire extinguishing system of FIG. 1, according to an embodiment of the present disclosure; and

FIG. 4 is a flow diagram illustrating a method of delivering fire extinguishing agent, according to an embodiment of the present disclosure.

### DETAILED DESCRIPTION

A detailed description of one or more embodiments of the disclosed apparatus and method are presented herein by way of exemplification and not limitation with reference to the Figures.

Various embodiments of the present disclosure are related to regulating pressure a fire extinguishing agent exiting a fire extinguishing tank. The fire extinguishing agent may specifically be halocarbon. Typically, halocarbon fire extinguishing tanks are pressurized with nitrogen, which acts as a propellant gas. Current tank valves open fully upon actuation thereby subjecting the pipe network to the full cylinder pressure. Schedule 40 pipe systems are preferred for cost reasons, however high tank pressure can require use of heavier pipe (e.g. Schedule 80) at greater cost. Storing the halocarbon-agent at high pressures offers many benefits to the fire extinguishing system including but not limited to increased storage capacity and increased coverage during application of the halocarbon-agent. High pressure storage of halocarbon without increased pipe cost is greatly desired.

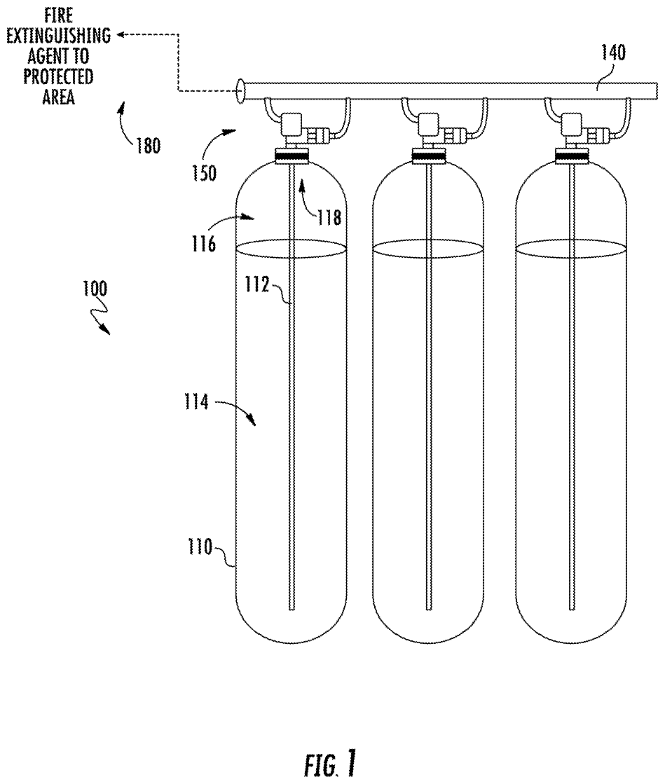

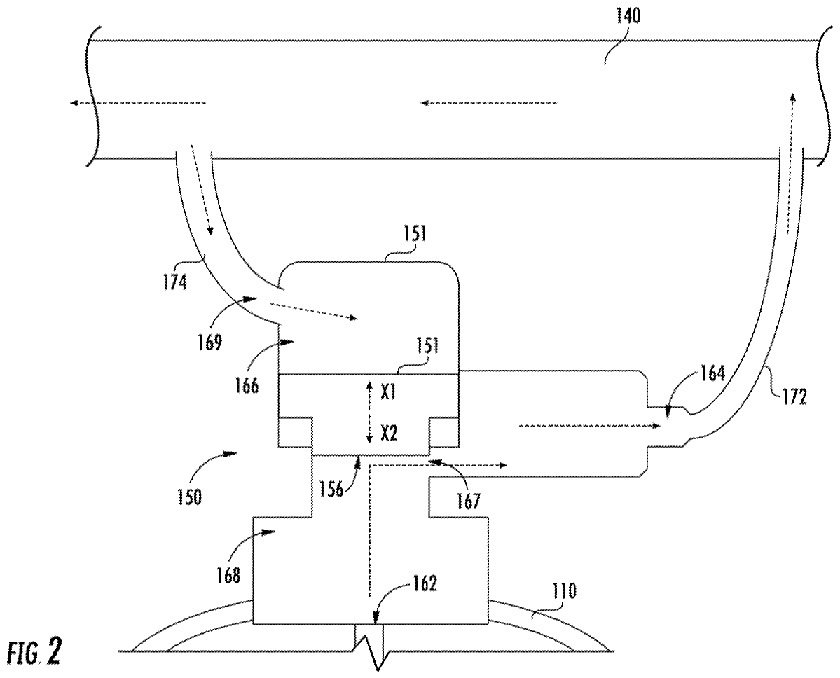

Referring to FIGS. 1 and 2, various embodiments of the present disclosure are illustrated. FIG. 1 shows a fire extinguishing system 100 and FIG. 2 shows valve 150 configured regulate fire extinguishing agent 114 exiting from a fire extinguishing tank 110. The fire extinguishing system 100 is configured to store fire extinguishing agent 114 and then release the fire extinguishing agent 114 to a protected area 180 when the valve 150 is opened. In an embodiment, the fire extinguishing agent 114 comprises halocarbon. As may be seen in FIG. 1, the fire extinguishing system 100 may include one or more fire extinguishing tanks 110. Each fire extinguishing tank 110 may be a seamless tank. The fire extinguishing tank 110 is configured to store fire extinguishing agent 114. The fire extinguishing tank 110 also stores a propellant 116 within the fire extinguishing tank 110. The propellant 116 is used to propel the fire extinguishing agent up the siphon tube 112 and through the valve 150 when the valve 150 is opened. In an embodiment, the propellant 116 may be nitrogen gas. The fire extinguishing tank 110 has an orifice 118 and the valve 150 is located in the orifice 150, The valve 150 is configured to regulate pressure of the fire extinguishing agent 114 exiting the fire extinguishing tank 110 when the valve is opened.

Advantageously, by regulating the pressure of fire extinguishing agent 114 exiting the fire extinguishing tank 110, the fire extinguishing agent 114 and the propellant 116 may be stored at higher pressures and then released at a lower pressure, which allows for lower strength distribution lines to be used and increases delivery distance of the fire extinguishing agent 114. For example, the fire extinguishing agent 114 and the propellant 116 may be stored at pressures greater than or equal to about 1800 psig in the fire extinguishing tank 110. Then the valve 150 may reduce the pressure to about 800 psig. Advantageously, by reducing the pressure, distribution lines may be composed at lower strength material, such as for example schedule 40 pipe as opposed to schedule 80 pipe that would be required for pressures greater than or equal to about 1800 psig. The distribution lines may include a manifold 140, as seen in FIG. 1, configured to deliver fire extinguishing agent 114 from one or more fire extinguishing tanks 110 to a protected area 180.

As seen in FIG. 2, the valve 150 may comprise: a valve housing 151; a valve inlet 162 fluidly connecting the valve housing 151 to the fire extinguishing tank 110; a valve outlet 164 in the valve housing 151; and a piston 152 within the valve housing 151. The piston 152 divides the valve housing 151 into a first chamber 166 and a second chamber 168 fluidly connecting the valve inlet 162 to the valve outlet 164 when the valve 150 is opened. When the valve 150 is opened, the fire extinguishing agent 114 will flow from the valve inlet 162 through a passageway 167 to the valve outlet 164. The size of the passageway 167 is adjusted by the position of piston 152. The piston 152 is configured to move within the valve housing 151 and adjust the flow of the fire extinguishing agent 114 through the second chamber 168. Moving the piston 152 in a first direction X1 increases the size of the passageway 167 and thus allows more fire extinguishing agent 114 through the valve 150. Moving the piston 152 in a second direction X2 decreases the size of the passageway 167 and thus allows less fire extinguishing agent 114 through the valve 150. When the valve 150 is opened the piston 152 is moved in the first direction X1 to allow fire extinguishing agent 114 to flow through the passageway 167. The piston 152 may be manually moved in the first direction X1 and/or when the valve 150 is opened the pressure from the fire extinguishing agent 114 may push the piston 152 in the first direction X1.

In an embodiment, the valve outlet 164 is fluidly connected to the first chamber 166, as seen in FIG. 2. The manifold 140 may fluidly connect the valve outlet 164 to the first chamber 166. As shown in FIG. 2, a first connector 172 may fluidly connect the valve outlet 164 to the manifold 140 and a second connector 174 may fluidly connect the manifold 140 to an inlet 169 of the first chamber 166. In the illustrated embodiment, the valve 150 utilizes pressure of the fire extinguishing agent 114 at the valve outlet 164 to regulate the release of the fire extinguishing agent 114. As seen in FIG. 2, the pressure of the fire extinguishing agent 114 at the valve outlet 164 acts on a first side 154 of the piston 152 proximate the first chamber 166. The piston 152 is configured to move in the second direction X2 when pressure at the valve outlet 164 exceeds a selected outlet pressure. Thus, the piston 152 will reduce the size of the passage way 167 and restrict the amount of fire extinguishing agent 114 released. The piston 152 also includes a second side 156 that may be opposite the first side 154. The first side 154 includes a first surface area and the second side 156 includes a second surface area. The first surface area may be greater than the second surface area. The ratio of the first surface area and the second surface area may be designed such that the piston 152 will move in the second direction X2 when pressure at the valve outlet 164 exceeds a selected outlet pressure. The selected outlet pressure may be a pressure above which the distribution lines may not be able to support.

Turning now to FIG. 3 while continuing to reference FIGS. 1-2, FIG. 3 shows a flow diagram illustrating a method 300 of assembling a fire extinguishing system 100 according to an embodiment of the present disclosure. At block 304, a fire extinguishing tank 100 having an orifice 118 is obtained. The fire extinguishing tank 110 is configured to store fire extinguishing agent 114. In an embodiment, the fire extinguishing agent 114 comprises halocarbon. At block 306, a valve 150 is inserted into the orifice 118. As mentioned above, the valve 150 is configured to regulate pressure of the fire extinguishing agent 114 exiting the fire extinguishing tank 110 when the valve 150 is opened. The method 300 may also comprise: filling the fire extinguishing tank 110 with a first selected amount of the fire extinguishing agent 114 at a selected pressure; and filling the fire extinguishing tank 110 with a second selected amount of propellant 116 at a selected pressure. The method 300 may further include fluidly connecting the valve outlet 164 to the first chamber 166.

While the above description has described the flow process of FIG. 3 in a particular order, it should be appreciated that unless otherwise specifically required in the attached claims that the ordering of the steps may be varied.

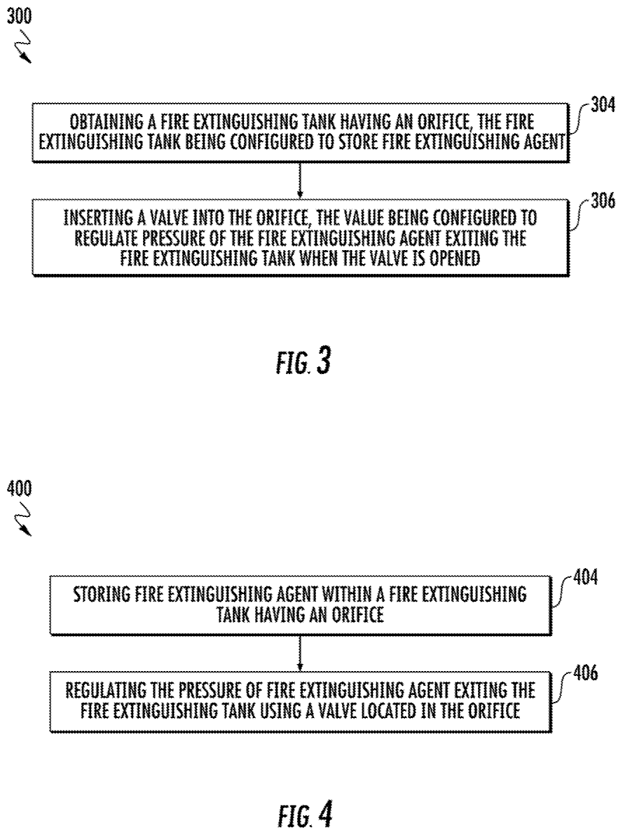

Turning now to FIG. 4 while continuing to reference FIG. 1-2, FIG. 4 shows a flow diagram illustrating a method 300 of delivering fire extinguishing agent 114, according to an embodiment of the present disclosure. At block 404, fire extinguishing agent 114 is stored within a fire extinguishing tank 110 having an orifice 118. At block 406, the pressure of fire extinguishing agent 114 exiting the tire extinguishing tank 110 is regulated using a valve 150 located in the orifice 118. In an embodiment, the fire extinguishing agent 114 comprises halocarbon.

While the above description has described the flow process of FIG. 4 in a particular order, it should be appreciated that unless otherwise specifically required in the attached claims that the ordering of the steps may be varied.

The term “about” is intended to include the degree of error associated with measurement of the particular quantity based upon the equipment available at the time of tiling the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may he substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out. this present disclosure, but that the present disclosure will include all embodiments falling within the scope of the claims.

What is claimed is:

1. A system for storing a fire extinguishing agent, the system comprising:
a fire extinguishing tank configured to store fire extinguishing agent, the fire extinguishing tank having an orifice; and
a valve located in the orifice configured to regulate pressure of the fire extinguishing agent exiting the fire extinguishing tank when the valve is opened;
wherein the fire extinguishing agent comprises halocarbon.

2. The system of claim 1, further comprising:
nitrogen gas located within the first extinguishing tank at a selected pressure, wherein the nitrogen gas propels the fire extinguishing agent through the valve when the valve is opened.

3. The system of claim 2, wherein:
the selected pressure of the nitrogen gas is greater than or equal to about 1800 psig.

4. The system of claim 1, wherein the valve further comprises:
a valve housing;
a valve inlet fluidly connecting the valve housing to the fire extinguishing tank;
a valve outlet in the housing; and
a piston within the valve housing, the piston dividing the valve into a first chamber and a second chamber, the second chamber fluidly connecting the valve inlet to the valve outlet when the valve is opened;
wherein the piston is configured to move within the valve housing and adjust the flow of the fire extinguishing agent through the second chamber.

5. The system of claim 4, wherein:
the valve outlet is fluidly connected to the first chamber.

6. The system of claim 5, wherein:
the piston further includes a first side proximate the first chamber and a second side proximate the second chamber; and
the first side includes a first surface area and the second side includes a second surface area, the first surface area being greater than the second surface area.

7. The system of claim 5, wherein:
the piston is configured to move when pressure at the valve outlet exceeds a selected outlet pressure.

8. The system of claim 6, wherein:
the piston is configured to move when pressure at the valve outlet exceeds a selected outlet pressure.

9. The system of claim 5, wherein:
the valve outlet is fluidly connected to the first chamber through a manifold configured to distribute the fire extinguishing agent when the valve is opened.

10. A method of assembling a fire extinguishing system, the method comprising:
obtaining a fire extinguishing tank having an orifice, the fire extinguishing tank being configured to store fire extinguishing agent;
inserting a valve into the orifice, the valve being configured to regulate pressure of the fire extinguishing agent exiting the fire extinguishing tank when the valve is opened;
wherein the fire extinguishing agent comprises halocarbon.

11. The method of claim 10, further comprising:
filling the fire extinguishing tank with a first selected amount of the fire extinguishing agent.

12. The method of claim 10, further comprising:
filling the fire extinguishing tank with a second selected amount of a nitrogen gas at a selected pressure, wherein the nitrogen gas propels the fire extinguishing agent through the valve when the valve is opened.

13. The method of claim 12, wherein:
the selected pressure of the nitrogen gas is greater than or equal to about 1800 psig.

14. The method of claim 10, wherein the valve further comprises:
a valve housing;
a valve inlet fluidly Connecting the valve. housing to the fire extinguishing tank;
a valve outlet in the housing; and
a piston within the valve housing, the piston dividing the valve into a first chamber and a second chamber, the second chamber fluidly connecting the valve inlet to the valve outlet when the valve is opened;
wherein the piston is configured to move within the valve housing and adjust the flow of the fire extinguishing agent through the second chamber.

15. The method of claim 14, further comprising:
fluidly connecting the valve outlet to the first chamber.

16. The method of claim 15, wherein:
the piston further includes a first side proximate the first chamber and a second side proximate the second chamber; and
the first side includes a first surface area and the second side includes a second surface area, the first surface area being greater than the second surface area.

17. The method of claim 15, wherein:
the piston is configured to move when pressure at the valve outlet exceeds a selected outlet pressure.

18. The method of claim 16, wherein:
the piston is configured to move when pressure at the valve outlet exceeds a selected outlet pressure.

19. The method of claim 15, wherein:
the valve outlet is fluidly connected to the first chamber through a manifold configured to distribute the fire extinguishing agent when the valve is opened.

20. A method of delivering fire extinguishing agent:
storing fire extinguishing agent within a fire extinguishing tank having an orifice; and
regulating the pressure of fire extinguishing agent exiting the fire extinguishing tank using a valve located in the orifice;
wherein the fire extinguishing agent comprises halocarbon.
